(19) United States
(12) Patent Application Publication
(10) Pub. No.: US 2010/0205566 A1
(43) Pub. Date: Aug. 12, 2010

(54) IMAGE FORMING APPARATUS AND IMAGE PROCESSING METHOD FOR DISPLAYING REDUCED-THUMBNAIL IMAGE

(75) Inventor: Tatsuo Matoba, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/688,291

(22) Filed: Jan. 15, 2010

(30) Foreign Application Priority Data
Feb. 10, 2009 (JP) 2009-028584

(51) Int. Cl. G06F 3/048

(52) U.S. Cl. 715/838; 715/853

(57) ABSTRACT

A image forming apparatus (MFP), because a display section thereof has a small window size, has a problem that much work is required for finding out a desired file or for carrying out processing on the found-out file. When displaying folders on the display section of the MFP, a way of extracting reduced-thumbnail images when the reduced thumbnail-images obtained by reducing the thumbnail images of contents included in the folders are extracted and displayed on icons of the folders to be displayed in a list, is set. Then, by displaying the reduced-thumbnail images on folder icons according to the extraction way, convenience of a user is improved.

### BACKGROUND OF THE INVENTION

1. Field of the Invention

The present invention relates to an image forming apparatus and an image processing method. More specifically, the present invention relates to an image forming apparatus and an image processing method for displaying a reduced-thumbnail image of image data included in sub-folders on each icon of the sub-folders on a thumbnail-list display screen.

2. Description of the Related Art

There is a function referred to as a box function or the like that is used for printing by storing and saving image data on a storage device included in an image forming apparatus (multi function peripheral, hereinafter represented as an MFP) and by browsing the saved image data by means of screen operation. In the box function, pieces of image data are classified and stored into folders, and when a user utilizes the image data, the user selects a desired piece of image data from the folders by means of screen operation and then carries out processing using a function of the MFP, such as printing.

When a large amount of image data is stored on the box, there has been a problem that it is difficult for a user to find out a desired piece of image data. As a technology for solving the problem, a searching function is provided in some cases. When the user knows attribute information (such as, name or date) of the object image data, the searching function can be used. However, if the attribute information is not clear, the user has to track each of the folders to confirm the pieces of image data one-by-one.

To make a user easily find out a desired piece of image data when the user tracks folders to search an image, a technology for displaying each piece of image data in a list using thumbnails has also been known. However, in a case where large amount of image data is stored or folders have multiple hierarchies, image searching by tracking folders has been a burden for a user because of large number of operations. Especially, because the size of an operation screen of the MFP is usually small, the number of images to be displayed in a list in one screen is limited. Therefore, even when images within one folder-hierarchy are displayed in a list, screen transition by a screen operation such as multiple times of switching of display screen pages has been necessary.

As an example of a prior art utilizing thumbnails of images stored on folders of a personal computer (hereinafter represented as a PC), there is “Windows (registered trademark) XP” (an OS of Microsoft (registered trademark) company). According to this, up to four thumbnails of data included in a folder can be displayed on a folder icon, thereby, enabling to glimpse the abstract of the data included in the folder before opening a folder in a lower hierarchy.

Furthermore, a technology for enabling operations (transferring, copying and deleting) of a file in a lower hierarchy by displaying a thumbnail of a file stored in a folder in the lower hierarchy on a folder icon, and operating the thumbnail on the folder icon, has also been known. This technology is disclosed in, for example, Japanese Patent Laid-Open No. 2005-004419 (hereinafter, referred to as Patent Document 1).

Suppose that a user has found out a folder including a desired file by displaying the thumbnail of a file to be displayed on a folder icon, which is stored on a lower hierarchy folder by applying the above-mentioned prior art to an MFP. Even in the case, because the size of the operation screen of the MFP is small, the number of images that can be displayed in a list on one screen is limited. For this reason, to display the desired file using a file view list in a folder including the desired file after the folder was found out, in some cases, screen transition by a plurality of screen operations is necessary. Therefore, it has been inconvenient and insufficient for the user operating the MFP to search the desired file using the prior-art technology.

As a specific example, suppose that a user operating the MFP is searching a group of files regarding a certain car which are collectively registered before on a folder at anywhere of a box so as to print (or send) them collectively. In this case, if the thumbnail for the car is displayed on a folder icon as the thumbnail of a piece of image data stored on a lower hierarchy folder, the user can just know that the desired file is stored on the corresponding folder. However, when only eight icons or the like can be displayed on the view list of the display section of the MFP in a case where a lot of (for example; one thousand) files are stored on the corresponding folder, the user has to switch display screen pages up to 124 times until the user arrives at the desired piece of data. Furthermore, if a lot of files are present on the corresponding folder, the thumbnail itself of the car may not be displayed on a folder, thereby, resulting in difficulty for finding out the corresponding folder itself.

Here, when the above-mentioned prior art is used, there is a possibility that display screen pages have to be switched many times until the desired group of files is displayed in a list using the operation section of the MFP, and this case has been insufficient for a purpose of reducing the number of screen operations of a user.

Thus, because the display section of the MFP has a small window size, even if the prior art is applied to the MFP directly, there has been a problem that much work is necessary for finding out an object file.

### SUMMARY OF THE INVENTION

The image forming apparatus according to the present invention includes: a thumbnail list display component configured to extract contents including files and folders having a hierarchy structure by a number to be displayed on a display section and to display a list of the extracted contents on the display section in a form of thumbnail images or icons; a reduced thumbnail image display component configured to extract, when displaying folders on the display section, reduced-thumbnail images obtained by reducing thumbnail images of the contents included in the folders and to display the reduced thumbnail images on an icon of the folder to be displayed in a list; and a reduced-thumbnail display setting component configured to set a way of extracting the reduced thumbnail images when they are displayed.

According to the present invention, for example, in a case where a user searches a file by tracking folders using an operation section of the MFP when a large number of files are stored on the box function of the MFP, there is an effect to improve the convenience of a user as will be described below.

That is, by setting a way of extracting the reduced-thumbnail image of a file stored on a lower hierarchy folder, to be displayed on a folder icon, the reduced-thumbnail image of the object file will be easily displayed on a folder icon. As a result, a user can easily find out the folder on which the object file is stored, which enables convenience of the user to be improved.

Further features of the present invention will become apparent from the following description of exemplary embodiments (with reference to the attached drawings).

### BRIEF DESCRIPTION OF THE DRAWINGS

FIG. 1 illustrates an example of schematic view of an image forming apparatus of the present invention;

FIG. 2 illustrates an example of the block diagram of an MFP control section of the present invention;

FIG. 3 illustrates an example of schematic view of an operation section of the present invention;

FIG. 4 illustrates an example of a box screen flow according to a prior art;

FIG. 5 illustrates an example of a box screen flow using intra-folder reduced-thumbnails according to the present invention;

FIG. 6 illustrates an example of a box screen flow using operation submenus according to the present invention;

FIG. 7 illustrates an example of an intra-folder thumbnail display setting screen according to the present invention;

FIG. 8 is a diagram showing the relationship of FIGS. 8A and 8B;

FIG. 8A illustrates an example of an image-information managing table according to the present invention;

FIG. 8B illustrates an example of an image-information managing table according to the present invention;

FIG. 9 is a diagram showing the relationship of FIGS. 9A and 9B;

FIG. 9A illustrates an example of a folder-information managing table according to the present invention;

FIG. 9B illustrates an example of a folder-information managing table according to the present invention; and

FIG. 10 illustrates an example of a flowchart from image selection to carrying-out of processing in the box function according to the present invention.

### DESCRIPTION OF THE EMBODIMENTS

Hereinafter, with reference to drawings, embodiments of the present invention will be described. In addition, the following description is intended only to give illustration, thereby, it is to be understood that the present invention is not limited to the drawings appended to this specification and the embodiments described in this specification.

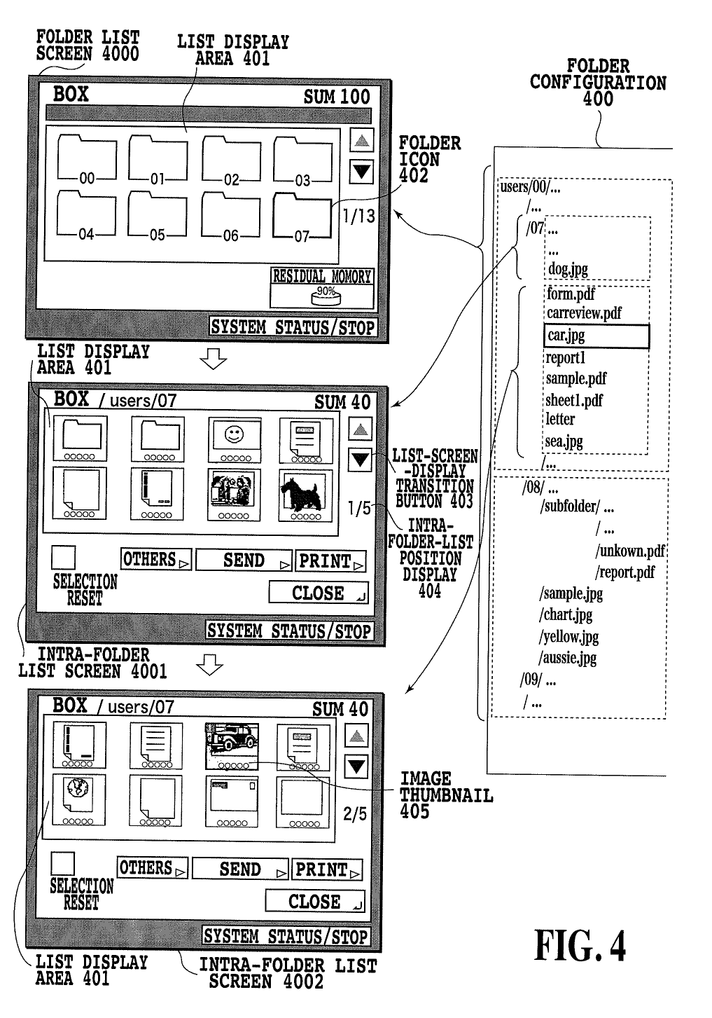

FIG. 4 illustrates an example of a screen operation where a user searches a list screen including image data called “car.jpg” for the purpose of printing etc. as a specific example of a prior art box function of a below described MFP 100 to which the present invention is not applied.

In the MFP 100, suppose that image data files are managed in a folder configuration as illustrated in a folder configuration 400. The folder configuration 400 in FIG. 4 has a hierarchy structure so that folders such as a folder “07” etc. are present as the lower folders of a “users” folder. A user searches the image data of “photographs of cars” using a folder list screen 4000 displayed on a touch panel section 301 of a below described operation section 300 of the MFP 100 as a starting point.

If a user does not know what kind of name the object piece of image data has and on which folder the object piece of image data is stored, the user will search all pieces of data on all folders by sequentially selecting eight folder icons 402 displayed on a list display area 401 named as “00” to “07”. Moreover, in some cases, the user will further search lower hierarchy folders of the above folders. For example, if a folder icon 402 named as “07” is selected, pieces of list of pieces of intra-folder image data and sub-folders as illustrated in an intra-folder list screen 4001 are displayed on the list display area 401 only just by a number that can be displayed on the list display area 401 (in this example; eight) at once. To display the list of the remaining pieces of intra-folder image data that can not be displayed on the area 401, a list screen display transition button 403 is pushed down. When the button 403 is pushed down, the thumbnail images of next eight pieces of image data to be displayed on the area 401 are acquired by the control of the MFP, and the thumbnail images of the eight pieces of image data are displayed on the area 401. An intra-folder list screen 4002 is an example of resultant screens displayed by repeating screen transition by pushing down the button 403 of the screen 4001. A user can find out an image thumbnail 405 showing the desired “photograph of a car” on the area 401 of the intra-folder list screen 4002, and can find out “car.jpg” that is the piece of image data indicated by the image thumbnail 405.

An intra-folder list position display 404 indicates at which rate the list of images (including eight images) is currently displayed in the entire folder. For example, if 40 pieces of image data are present in one folder, and the number of images that can be displayed on the list display area 401 is eight, “1/5” will be displayed on the display 404. Next, if a user pushes down a list-screen-display transition button 403 once, the screen will transit to another one and next eight thumbnails will be displayed on the list display area 401, and “2/5” will be displayed on the display 404.

Thus, when a user forgets the folder on which object image data is stored or the attribute information of the image data, the work of the user for searching the desired image data by operating the operation section 300 of the MFP 100 has required a large number of operations until the user finds out the object image data, thereby, resulting in burden for the user.

Hereinafter, with reference to drawings, preferred embodiments of the present invention, for solving the above-mentioned problems will be described in a more detailed manner.

### Device Configuration

In the present embodiment, an example of an image forming apparatus according to a representative embodiment of the present invention will be described.

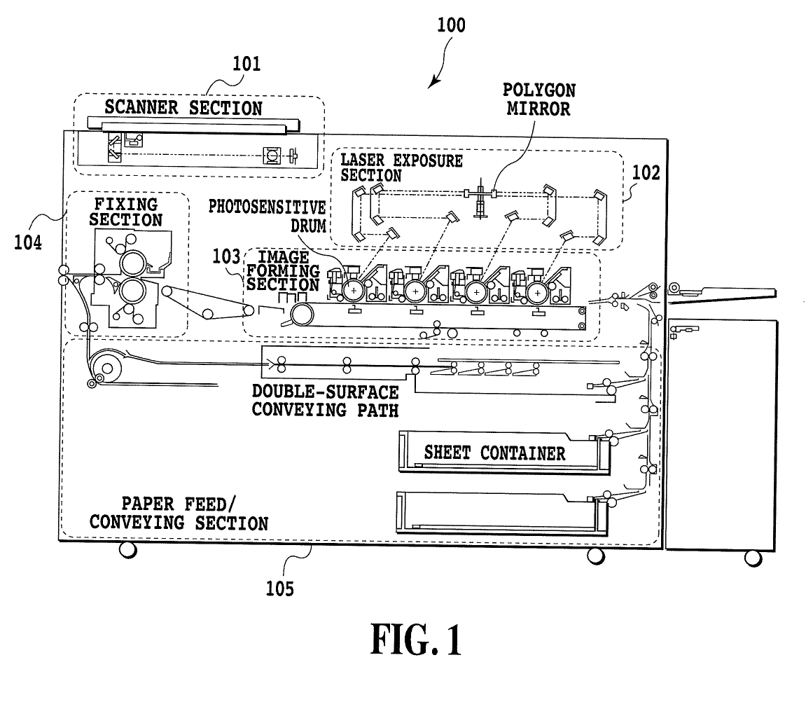

FIG. 1 illustrates the internal structure of the MFP 100 serving as an image forming apparatus according to the embodiment of the present invention. The MFP 100 is an image forming apparatus having various functions such as scan, print, copy, send and box (a function of storing images on a storage area in an apparatus for a purpose of reprinting etc.). There are monochrome apparatuses and color apparatuses as for the MFP, and because they have different processing speeds and costs, they are used depending on their intended uses. However, because the full-color apparatuses has the configuration including that of the monochrome apparatuses in many cases, except for color processing and their internal data, the full-color apparatuses will be mainly described here.

The MFP 100 being a full color MFP includes a scanner section 101, a laser exposure section 102, an image forming section 103 having a photosensitive drum, a fixing section 104, a paper feed/conveying section 105, and an MFP control section 200 for controlling these sections, which will be described below.

The scanner section 101 optically scans a document image by irradiating illumination onto a document placed on a platen, and generates image data by converting the scanned image into an electrical signal.

The laser exposure section 102 causes a beam such as a laser beam or the like, modulated according to the image data, to enter on a rotary polygonal mirror (polygon mirror) which rotates at an equal angular velocity, and irradiates the photosensitive drum with the reflected light as a reflected scanning beam.

The image forming section 103 rotates to drive the photosensitive drum, charges it by a charger, develops a latent image formed on the photosensitive drum by the laser exposure section with toner, and transfers the toner image onto a sheet. At that time, the section 103 recovers a minute amount of toner which remains untransferred on the photosensitive drum. The section 103 is realized by including four developing units (developing stations) for a series of such electrophotography processes. In the four developing units for cyan (C), magenta (M), yellow (Y), and black (K) serially arranged in this order, the cyan station starts image forming operation, then after a predetermined time, the magenta station, the yellow station and the black station sequentially start image forming operation, respectively. By controlling this timing, a full-color toner image is transferred on a sheet without color shift.

The fixing section 104 includes a combination of rollers and a belt, and incorporates a heat source such as a halogen heater. The section 104 melts and fixes the toner by heat and pressure on the sheet, on which the toner image has been transferred by the image forming section.

The paper feed/conveying section 105 includes one or more sheet containers represented by a sheet cassette or a paper deck. According to an instruction from the MFP control section 200, one sheet out of a plurality of sheets stored in a sheet container is separated and conveyed to the image forming section 103 and the fixing section 104. The sheet is conveyed to the section 104, and toner images of respective colors are transferred on the sheet by the above-described developing stations, and, finally, a full-color toner image is formed on the sheet. Further, for forming images on both surfaces of the sheet, the sheet which passed through the fixing section 104 is controlled to pass a conveying path for conveying the sheet to the image forming section 103 again.

The MFP control section 200 controls the entire MFP 100, and instructs the sections of scanner, laser exposure, image forming, fixing, and paper feed/conveying so that all these sections can operate smoothly in coordination, while managing the states of the sections.

Note that the configuration of this system may include a plurality of MPFs 100 or it may be combination of a plurality of MFPs. Moreover, a configuration of combination of an MFP and an SFP (single function peripheral) having a print function only may be used. Furthermore, a configuration of combination of a network connection device and a general-purpose PC including a CPU, a ROM, a RAM, an HOD and the like may also be used. Anyway, any configuration enabling to achieve the control of this form may be used.

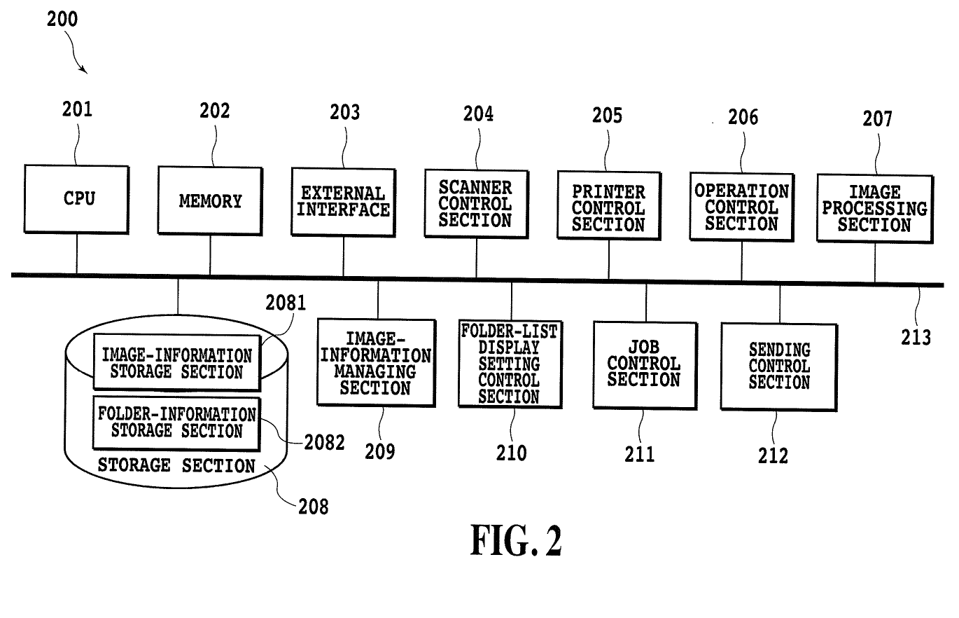

FIG. 2 is a block diagram illustrating the configuration of the MFP control section 200 included in the MFP 100 according to the embodiment of the present invention illustrated in FIG. 1. In the FIG. 2, a scanner control section 204, a printer control section 205, an operation control section 206, an image processing section 207, an image-information managing section 209, a folder-list-display setting control section 210, a job-control section 211, and a sending-control section 212 are processing modules which constitute the MFP control section 200. These processing modules are modules each operating as an application program or a part of the program used by the CPU 201. Moreover, the processing modules are modules each constituting a thumbnail-list display component, a reduced-thumbnail-image display component, a reduced-thumbnail display setting component, and a processing-operation setting component.

In the figure, a storage section 208 and an image-information storage section 2081 and a folder-information storage section 2082 that are parts of the storage section 208 are information storage devices constituting the MFP control section 200, which store information on a non-volatile hard-disc and memory using a file system or a database system. Moreover, it is possible to directly access to specific information among information stored on the storage section 208 using a specific key or under a specific condition.

The CPU 201 controls the entire MFP 100, and realizes operations such as those of scan, print and facsimile by reading out a program stored on the memory 202 or the storage section 208 and to execute it.

The memory 202 includes a ROM for storing various programs executed by the CPU 201, and a RAM for temporarily storing data necessary for control. The various programs are ones for realizing functional sections, such as, the scanner control section 204, the printer control section 205, the operation control section 206, the image processing section 207, the image information managing section 209, the folder-list-display setting control section 210, the job control section 211, and sending-control section 212.

An external interface 203 exchanges information with another external MFP 100 or PC having a similar configuration, via a network or a detachable external storage device (not shown in the figure).

The scanner control section 204, according to an instruction from the CPU 201, controls to drive the scanner section 101, scans a document on the platen and stores the scanned image on the memory 202.

The printer control section 205, according to an instruction from the CPU 201, acquires image data from the memory 202 or the image-information storage section 2081 of the storage section 208, and outputs an image by printing it by controlling the laser exposure section 102, the image forming section 103, the fixing section 104, and the paper feed/conveying section 105.

The operation control section 206 operates according to an instruction from the CPU 201 to control the operation section 300 including the touch panel section 301 and a key input section 302 provided in the MFP 100. Information generated when a user operates these sections is sent to each section, and the MFP 100 operates.

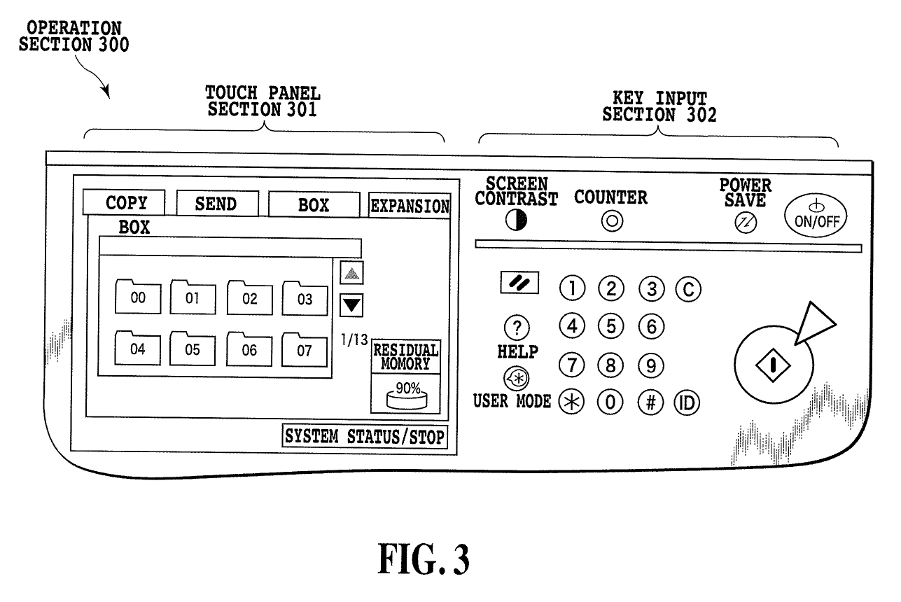

FIG. 3 is an example of the schematic view of the operation section 300. In the figure, the touch panel section 301 is schematically illustrated with including an LCD (liquid crystal display) and a touch panel display which includes a transparent electrode attached thereon. In the present embodiment, the section including them is referred to as a display section. If parts of the transparent electrode corresponding to keys displayed on the LCD are touched by fingers, the touch panel section 301 is programmed in advance so as to detect the touch and to display another operation screen. The key input section 302 is a key inputting part enabling to carry out routine operation setting, and a power switch, a start key, a reset key, ten key and the like are arranged in this section. The “operation screen” described in the present embodiment is displayed on the touch panel section 301 as a screen.

The image processing section 207 operates according to an instruction from the CPU 201 to carry out image processing and processing for improving image quality instructed via the operation control section 206 by an operator and to analyze the image data stored on the memory 202 by the scanner control section 204.

The image information managing section 209 operates according to an instruction from the CPU 201 to manage registering, referring, updating, and deleting of the image data stored on the image information storage section 2081 of the storage section 208. In addition, the image information managing section 209 may also manage print setting information (kind of paper, size of paper, color segmentation, double/single surface, and the like) associated with the image data by causing the image information storage section 2081 to store the information.

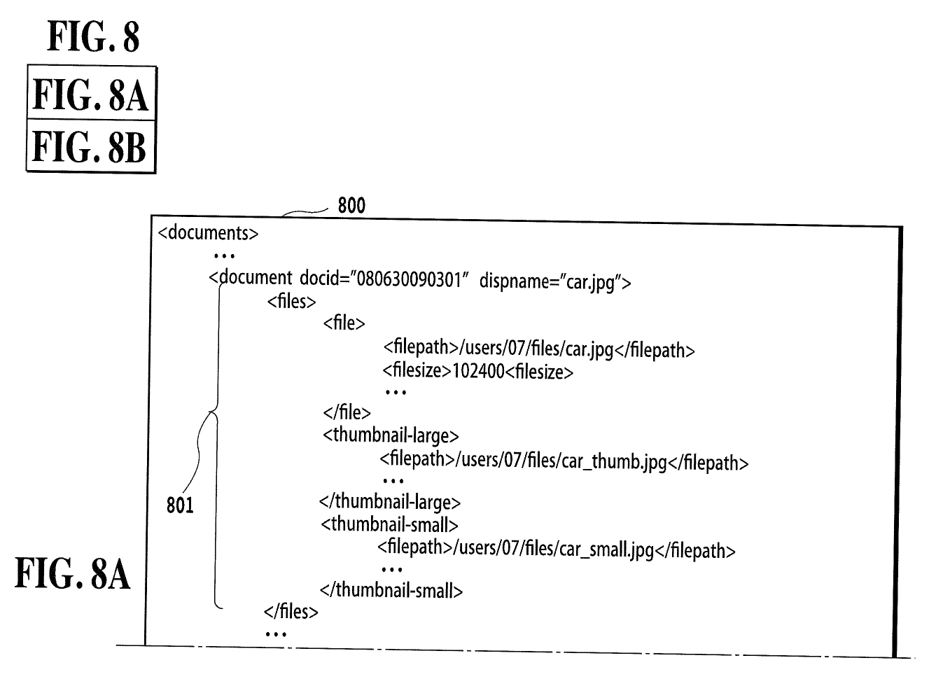

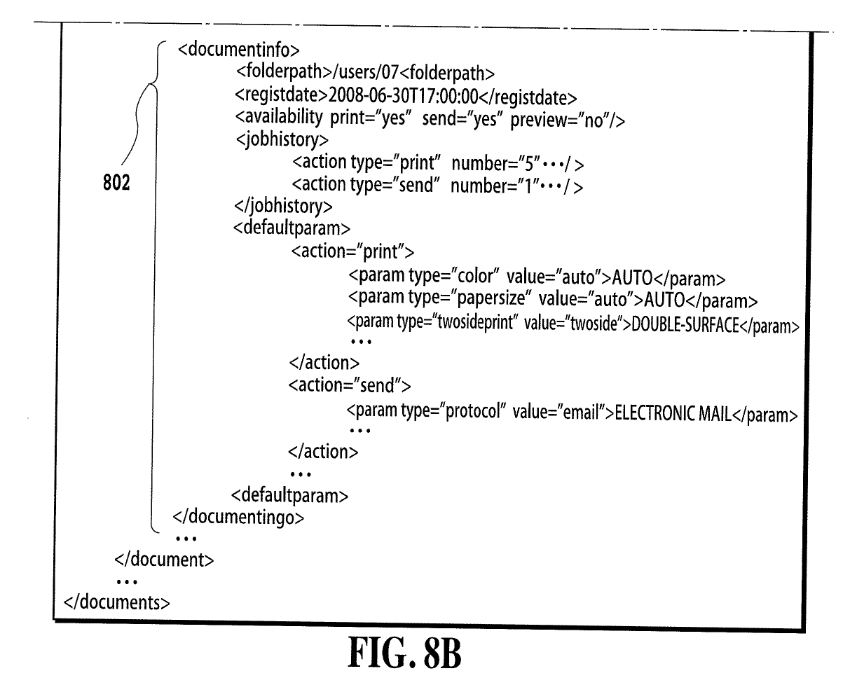

FIG. 8A and FIG. 8B are an image view of an image-information managing table 800 where an example of managing information of image files to be stored on the image-information storage section 2081 is shown in XML format.

The image-information managing table 800 illustrates a part of the configuration of image information to be uniquely identified with a “docid” attribute of a “document” element. Moreover, in the table 800, a part of the configuration of image information to be displayed using a display name as “car.jpg” with a “dispname” attribute on the operation screen on the touch panel section 301 of the operation section 300 is also illustrated.

A “files” element 801 manages information of a real file on a file system associated with the image information. The “files” element 801 includes a “file” element, a “thumbnail-large” element, a “thumbnail-small” element, and the like. In the “file” element, the file path of image data is shown. In the “thumbnail-large” element, the file path of thumbnail data to be displayed on a list of images of the operation screen is shown. In the “thumbnail-small” element, the file path of reduced thumbnail data (reduced-thumbnail images) to be displayed on a folder icon of the operation screen is shown.

A “documentinfo” element 802 manages information for operations in the MFP related to the image data. The “documentinfo” element 802 includes a “folder-path” element, a “registdate” element, an “availability” element, a “jobhistory” element, a “defaultparam” element and the like. The “folder-path” element shows a folder path when the folder is displayed by a box function. The “registdate” element shows the date when the image data was registered. The “availability” element shows information whether the image data can be used by functions of the MFP such as a “print” function and a “send” function. The “jobhistory” element shows information of the number of jobs of “print” or “send” carried out using the image data, information of the date when the jobs were carried out and information of the results of the jobs. The “defaultparam” element shows default setting when jobs of “print” and “send” are carried out. When the job is a print job, print setting, such as color: auto, paper size: auto, print surface: double surfaces, is held.

The folder-list-display setting control section 210 operates according to an instruction from the CPU 201 to manage registering, referring, updating, and deleting of the folder data stored on the folder information storage section 2082 of the storage section 208.

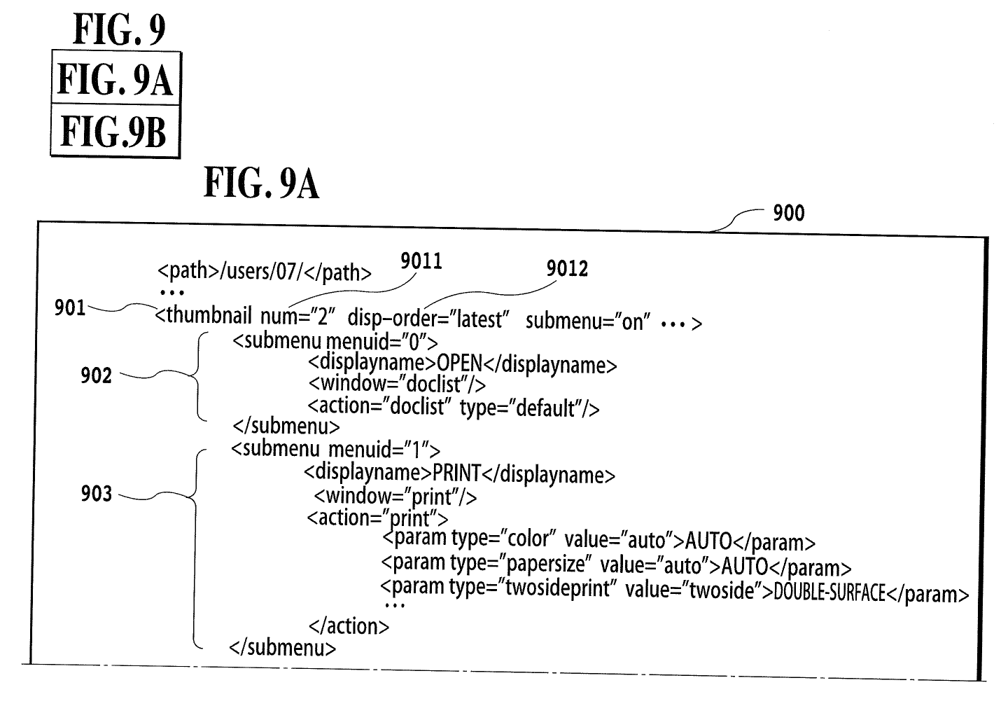

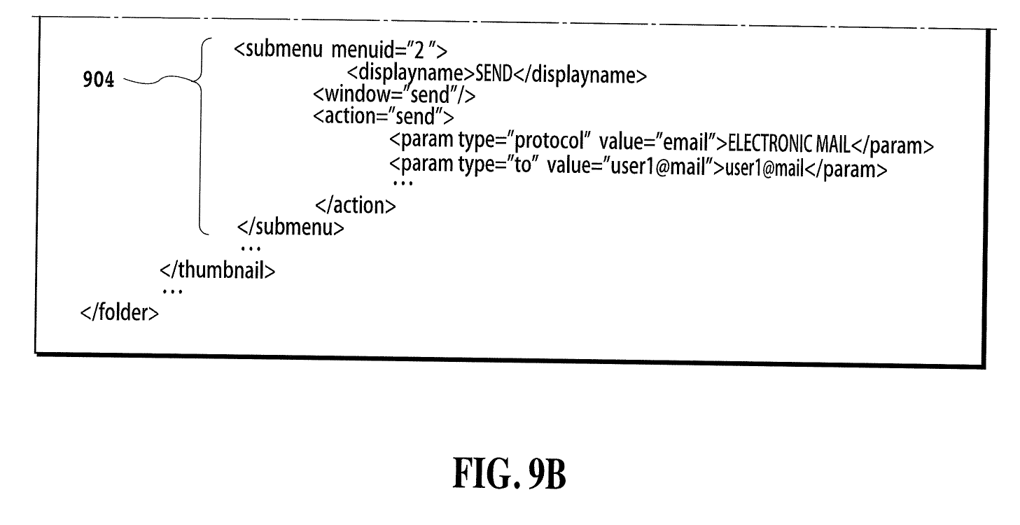

FIG. 9A and FIG. 9B are an image view of folder-information managing table 900 where an example of managing information of folders to be stored on the folder-information storage section 2082 is shown in XML format.

A folder-information managing table 900 illustrates a part of the configuration of folder-information to be displayed using a display name as “07” with a “dispname” attribute of a “folder” element on the operation screen on the touch panel section 301 of the operation section 300.

### Reduced-Thumbnail Image

A “thumbnail” element 901 shows, when the folder is displayed by a folder icon, information (9011, 9012 etc.) regarding to displaying reduced-thumbnail images of image data stored on lower hierarchy folders, to be displayed on the folder icon.

The “num” attribute 9011 shows the number of reduced-thumbnail images to be displayed on a folder icon. The “disp-order” attribute 9012 shows choice criteria (extraction criteria) of the reduced-thumbnail images to be displayed on the folder icon. Examples of choice criteria of reduced-thumbnail images include; selection of designation number in reverse chronological order of updated date of each piece of image data included in a folder; selection of designation number in descending order of usage frequency of each piece of image data included in a folder; selection of designation number sorted in ascending order of names of each piece of image data included in a folder; selection of designation number out of the total number of a list sorted in ascending order at regular intervals; selection of a kind of files; and selection of a file out of files by weighted importance of information associated with the files. These criteria may be set in combination of a plurality of criteria, for example, selection of “image data” out of kinds of files as a first criterion, and selection of designation number in reverse chronological order of updated date of each piece of data as a second criterion.

Thus, by setting a way of extracting reduced-thumbnail images in a case where the reduced-thumbnail images are displayed, a user can search an object file by referring the state (for example, a newly updated file) of the desired file. Because, in many cases, the user knows the state of the desired file in any way, by setting a suitable extraction way, the user can easily find out a folder including the object file of the user.

### Setting Menu

A “submenu” element 902 holds, when a reduced-thumbnail image displayed on a folder icon is selected, setting regarding a submenu (setting menu) for displaying a function to be carried out on the corresponding image data. A “displayname” element shows the name of the function to be displayed on the submenu, a “window” element shows an operation screen to be displayed in selection of submenu, and an “action” element shows an operation to be carried out in selection of submenu. The “submenu” element 902 illustrates an example of a case of carrying out a default operation of “opening” an image list screen including the corresponding image data.

Moreover, as an example of “print” is illustrated in a “submenu” element 903, and an example of “send” is illustrated in a “submenu” element 904, when it is set print or send using submenu, parameters of print and send used when carrying out the operations can also be set.

Thus, by setting a processing operation when selection of a reduced-thumbnail image to be displayed on a folder icon is detected, the following effects will be achieved. First, an example of a case of “opening” that is a default operation, will be described. This example is especially useful when a large number of files are included in a folder on which an object file is stored. Suppose that a user found out reduced-thumbnail images of the object file on an icon of a lower hierarchy folder. In this case, it has been necessary for a prior art to carry out work for searching the object file for a long time by repeatedly displaying lists in folders that can be displayed only in a limited number, as the subsequent processing. On the contrary, if a user selects a reduced-thumbnail image (for example, if the corresponding part on a touch panel is pushed down) in a way of this example, a page including the reduced-thumbnail image will be opened. That is, a list of contents of a folder where a content shown by the selected reduced-thumbnail image is stored, including the content is displayed. This enables complicated work as in a prior art to be eliminated, in order to find out the object file.

In addition, setting of folders may be one common to the entire MFP. Alternatively, as illustrated in FIG. 9A and FIG. 9B, a configuration where each folder has individual setting may be used. This enables more flexible management to be achieved.

The job control section 211 operates according to an instruction of the CPU 201 to control setting and execution of jobs such as copy, box print, printer and send which are carried out by the MFP 100. In execution of jobs by the job control section 211, by instructing the scanner control section 204, the printer control section 205, the image-information managing section 209 and the sending-control section 212, job execution is instructed and monitored.

The operation control section 206 detects operations of a user via the operation section 300 and via applications such as a facsimile and an electronic mail. Then, the sending-control section 212 sends image data acquired from the memory 202 and the image-information storage section 2081 of the storage section 208, to outside via the external interface 203. Inversely, the sending-control section 212 may receive image data sent from outside to store the data on the section 2081 of the storage section 208.

An internal bus 213 has a function to connect between sections illustrated in FIG. 2, and transfer of image data, instruction to each of the sections, and send/reception of set values are carried out via the bus 213.

### Specific Example

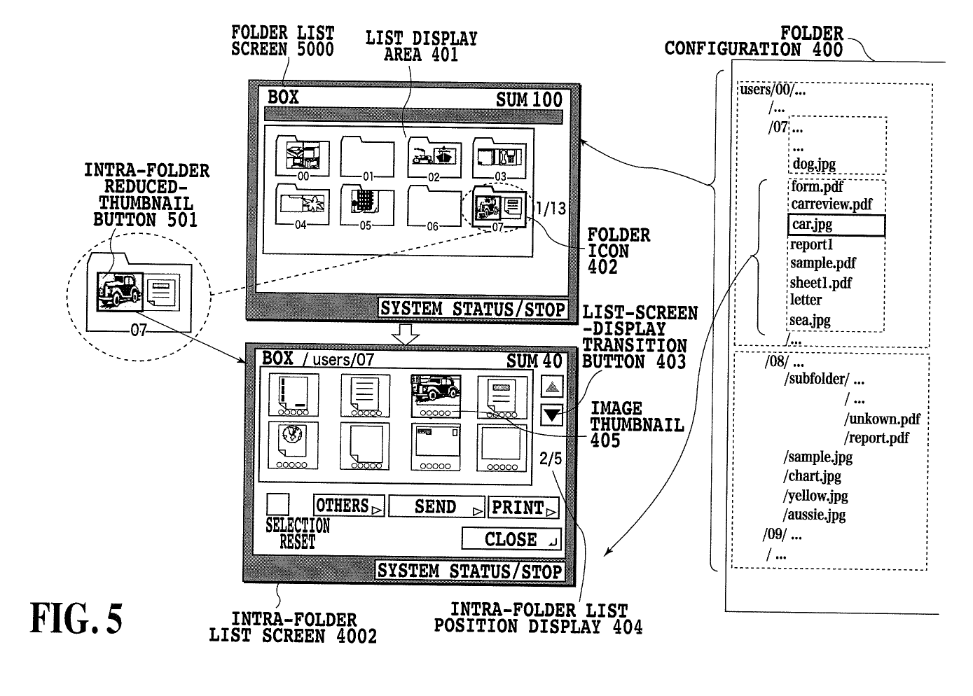

FIG. 5 illustrates a specific example of the box function of the MFP 100 according to the present invention. In FIG. 5, an example of a screen operation of a user for searching image data (“car.jpg”) of “car photograph” using, as a starting point, a folder list screen 5000 to be displayed on the touch panel section 301 of the operation section 300 of the MFP 100.

It has not been possible for the above-described prior art to set a way of extracting thumbnails of files stored on lower hierarchy folders, to be displayed on the folder icon. To make a user easily find out a desired file when the user searches the object file by tracking folders in the storage device of the MFP, it is desirable for the user to extract a file suitable to the object out of files by displaying the files on folder icons as thumbnails depending on the object. However, with the technology described in Patent Document 1, it has been not possible for a user to arbitrarily set a way of extracting contents. Thus, in the present embodiment, to make a user easily extract the object file, an example where the user can arbitrarily set a way of extracting contents shown by reduced-thumbnail images will be described.

Suppose that image data files are managed in a folder configuration (the same configuration as that illustrated in FIG. 4) as illustrated in the folder configuration 400 by the image-information storage section 2081 and the folder-information storage section 2082 provided to the storage section 208 of the MFP control section 200 of the MFP 100. The folder list screen 5000 in FIG. 5 is a screen where contents including files and folders that have a hierarchy structure are extracted by a number that can be displayed on a display section at once, and the extracted contents are displayed in a list on the display section in a form of thumbnail images or icons.

On each of the plurality of folder-icons 402 displayed on the list display area 401 of the folder list screen 5000, an intra-folder reduced-thumbnail button 501 showing a piece of image data extracted out of pieces of image data included in folders is displayed. The intra-folder reduced-thumbnail button 501 is based on a piece of image data specified by the file path of the reduced-thumbnail data in the management information of image files, illustrated in FIG. 8A and FIG. 8B. A user, by browsing the reduced-thumbnail images displayed on the button 501 of each folder, can analogize image data included in each folder without browsing the folder by opening the contents by a screen operation. Moreover, by browsing the reduced-thumbnail image, the user can obtain clues for searching a desired piece of image data. Here, if the reduced-thumbnail displayed on the button 501 is the desired piece of image data of “photograph of a car”, the user will push down the button 501. Then, in this example, the intra-folder list screen 4002 including the pieces of image data “car.jpg” indicated by the image thumbnail 405 showing the desired “photograph of a car” is displayed on the area 401. In this case it is possible to directly transit to the screen 4002 including the “car.jpg” without repeating the screen transition by pushing down the list-screen-display transition button 403 as described in FIG. 4. Note that, in FIG. 5, a screen has been transited into 2/5 page including “car.jpg” of the “07” folder in a manner of one click. According to the present embodiment, it is possible for the user to display a list of a desired file group on the operation section of the MFP only by one operation of selecting the thumbnail for the corresponding car on a folder icon. Moreover, it is possible to gather file groups regarding a car so as to reduce the number of screen operations until printing (or sending) operation. Especially, in a case where a large number of files (for example, 1,000 files) are stored on the corresponding folder, when only eight files can be displayed on the list display of the display section of the MFP, the present embodiment is useful. That is, because the number of screen operations of a user for searching a file can be reduced significantly, the effect for improving convenience of the user will be remarkable.

The module control when the intra-folder reduced-thumbnail button 501 is pushed down by a user, is as follows: First, when the operation control section 206 detects that the button 501 is pushed down, the folder-list-display setting control section 210 selects an operation for “opening” a screen list that is a default operation from the folder-information managing table 900 that is stored in the folder-information storage section 2082. Next, the image-information managing section 209 extracts the folder (/users/07) including a piece of image data indicated by the reduced-thumbnail image displayed on the button 501 referring to the image information managing table 800 stored on the image-information storage section 2081. Next, the image information managing section 209 sequentially selects the number of (eight) pieces of image data that can be displayed on the list display area 401 at once from the list of the entire pieces of image data included in the above folder from the head of the list. Then, eight pieces of image data including the piece of image data indicated by the reduced-thumbnail image displayed on the button 501 are selected. Subsequently, by the control of the section 206, the intra-folder list screen 4002 including “car.jpg” is displayed on the area 401.

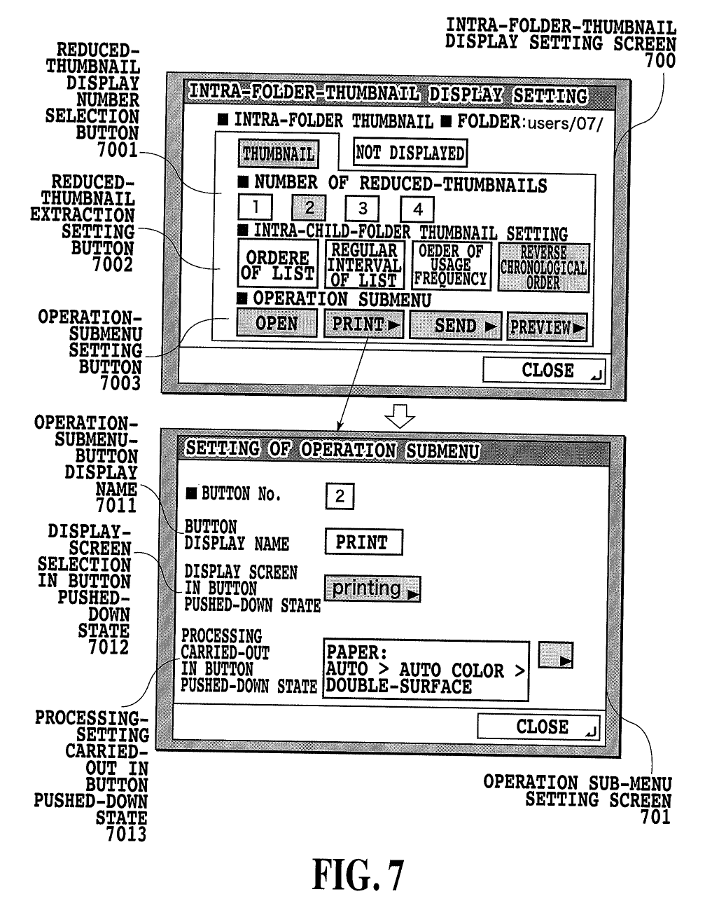

FIG. 7 illustrates an example of an intra-folder thumbnail-display setting screen 700 for carrying out setting regarding a reduced-thumbnail image to be displayed on the intra-folder reduced-thumbnail buttons 501 displayed on the folder icon 402 described in FIG. 5.

A reduced-thumbnail-display-number selection button 7001 is a button for selecting the number of the buttons 501 displayed on the folder icon 402. Here, an example of screen where the number of the buttons 501 can be selected in a range from one to four.

A reduced-thumbnail-extraction setting button 7002 is a button for setting the choice criteria (extraction criteria) of the reduced-thumbnail images each displayed on one of the intra-folder reduced-thumbnail buttons 501 displayed on the folder icon 402. For example, when “reverse chronological order” is selected, pieces of image data are selected at a designation number designated by the reduced-thumbnail-display-number selection button 7001 in reverse chronological order of updated date of the pieces of image data included in the folder. When “usage frequency order” is selected, pieces of image data are selected at a designation number in descending order of usage frequency of the pieces of image data included in the folder. When “list order” is selected, pieces of image data are selected at a designation number from the head of sorted order (for example, order of name) of the pieces of image data included in the folder. When “list of regular interval” is selected, pieces of image data are selected at a designation number from the whole at regular intervals in sorted order (for example, order of name) of the pieces of image data included in the folder.

The folder-list-display setting control section 210 stores the contents set on the intra-folder thumbnail display setting screen 700 on the folder-information managing table 900 that is stored in the folder-information storage section 2082. The value selected by the reduced-thumbnail-display-number selection button 7001 is stored on the table 900 as the “num” attribute 9011, and the value selected by the reduced-thumbnail-extraction setting button 7002 is stored on the table 900 as the “disp-order” attribute 9012. In addition, although a case for individually carrying out setting for each folder is described in this example, it is also possible to store various set values on the table 900 by selecting the values as setting common to all folders.

According to the technology described in the prior art in Patent Document 1 described above, it has not been possible for a user to change setting of a way of extracting the reduced thumbnail of a piece of image data stored on a lower hierarchy folder displayed on a folder icon.

By setting various conditions using the intra-folder thumbnail display setting screen 700 according to the present invention, a user can change the setting of the above-mentioned extraction way. For example, if a user intends to utilize a currently updated image again, the user can rapidly find out a folder where an object file is stored by changing the extraction way into a way using a “reverse chronological order”. Therefore, it is possible to improve convenience of the user in screen operation when the user searches image data.

In addition, in an example illustrated in FIG. 5, a case where each of the intra-folder reduced-thumbnail buttons 501 is displayed on an icon, has been described. However, in this specification, a state where each of the buttons 501 is displayed “on an icon” may not be a state where all reduced-thumbnail images are included on the display of each of folders and displayed thereon. For example, reduced-thumbnail images may be displayed protruding from the folder. Moreover, a configuration where folders are transparent and reduced-thumbnails are displayed on the back surface of the folders may also be used.

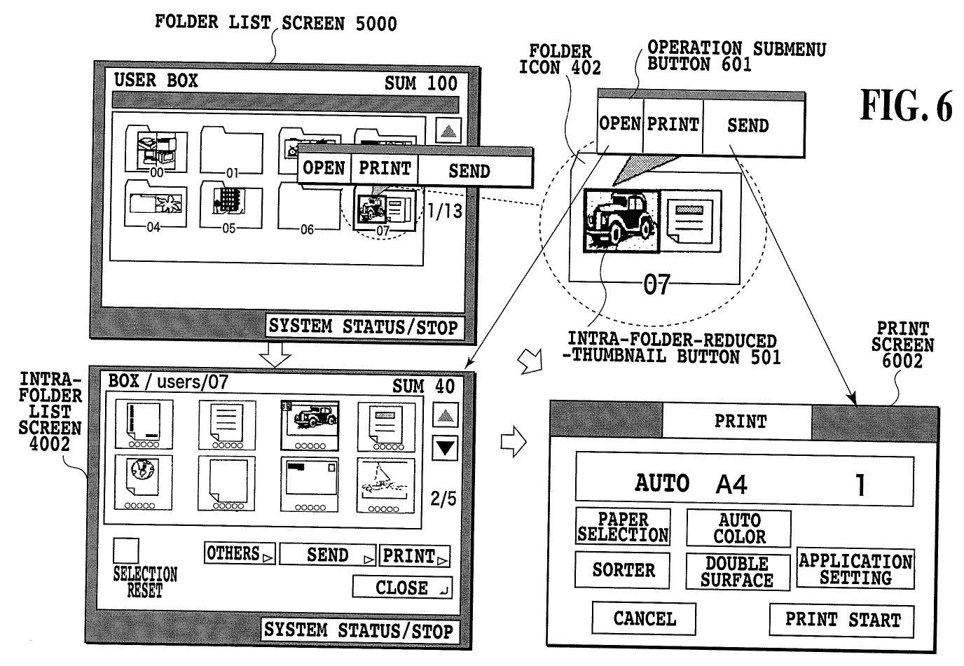

FIG. 6 illustrates an example of screen operation where a user searches the image of “car.jpg” to print it, as a specific example of the box function of the MFP according to the present invention. That is, FIG. 6 shows an example of processing operation when detecting that the reduced-thumbnail image to be displayed on the folder icon is selected.

According to the technology described in Patent Document 1, by operating the thumbnail of a file stored on a lower hierarchy folder to be displayed on a folder icon, file operations (deleting, and copying) on the file itself can be carried out. However, functions of the MFP using a file, such as a print function and a send function, were not able to be activated. Thus, in the present embodiment, an example where functions specific to the MFP are activated, will be described.

As described in FIG. 5, on each of the plurality of folder icons 402 displayed on the list display area 401 of the folder list screen 5000, the intra-folder reduced-thumbnail button 501 showing a piece of image data extracted out of pieces of image data included in folders is displayed. In FIG. 5, a case where an operation for “opening” an image list is set as a default operation when the button 501 is pushed down, has been described. In FIG. 6, a case where a plurality of operations (printing, sending and the like) is arbitrarily set by a user, as the operation when the button 501 is pushed down, will be described. That is, a case where a processing operation when it is detected that a reduced-thumbnail image to be displayed on a folder icon is selected is set, will be described.

If a user pushes down an intra-folder reduced-thumbnail button 501, operation submenu buttons 601 will be displayed. By selecting an object operation out of the submenu buttons 601, the user can carry out a default operation to “open” a list screen by directly transiting to the intra-folder list screen 4002. That is, the user can display a list of the contents of a folder where the contents shown by the selected thumbnail image are stored and the contents shown by the reduced-thumbnail image. In addition, the user can activate functions to “print” and “send” the corresponding image data. Furthermore, the user can also activate a function of “preview display”.

For example, when “print” is selected out of the operation submenu buttons 601 displayed accompanied with the selection of the reduced-thumbnail image, as illustrated on the print screen 602, a screen where setting of print is carried out is displayed. Then, printing of the image “car.jpg” indicated by the intra-folder reduced-thumbnail button 501 can be started.

The module control when a user pushes down the intra-folder reduced thumbnail button 501 is as follows:

First, the operation control section 206 detects that one of the intra-folder reduced-thumbnail buttons 501 is pushed down. Next, the folder-list-display setting control section 210 extracts items registered as the “submenu” elements 902 and 903 from the folder-information managing table 900 stored on the folder-information storage section 2082. Then, the section 210 extracts names such as “open”, “print”, and “send” set in the “displayname” element. Subsequently, by the control of the section 206, the operation submenu buttons 601 are displayed near the corresponding button 501 displayed on the touch panel section 301.

Setting of button to be displayed on each of the operation submenu buttons 601 can be carried out by using operation submenu setting buttons 7003 on the intra-folder thumbnail display setting screen 700 in FIG. 7.

If one button out of the operation submenu setting buttons 7003 is pushed down, an operation submenu setting screen 701 is displayed. On an operation submenu button display name 7011, a button name (“print” in the example of FIG. 7) to be displayed on the button 601 can be set. On a display-screen-selection in button pushed-down state 7012, an identifier (“printing” in the example of FIG. 7) indicating a screen to be displayed when the corresponding button 601 is pushed down. On a processing setting carried-out in button pushed-down state 7013, when the corresponding button 601 is pushed down, an operation to be carried out on the display-screen-selection 7012 and parameters to be handed over during carrying out the operation can be set. When “print” is set as the operation submenu button 601, default setting of print (“paper size; auto, color; auto, and double-surface” in the example of FIG. 7) can be set on the processing setting 7013.

Thus, according to the present embodiment, a processing operation of a case when it is detected that a reduced-thumbnail image to be displayed on an folder icon is selected, can be set. In addition, as illustrated in the example of FIG. 6, when it is detected that the reduced-thumbnail image is selected by setting a plurality of processing operations, it is possible to present the setting menu (operation submenu) regarding the setting of the plurality of processing operations to a user. Then, based on a selection input of the user, the selected processing operation can be carried out. Moreover, as illustrated in the example of FIG. 5, single processing operation such as default setting can also be set. In this case, when it is detected that the reduced-thumbnail image is selected, the set processing operation can be carried out without presenting the operation submenu to the user. These settings can be carried out for each folder individually. Alternatively, setting common to all folders can also be set.

The contents set on the operation submenu setting screen 701 are stored on the “submenu” element 903 of the folder-information managing table 900 that is stored in the folder-information storage section 2082 by the control of the folder-list-display setting control section 210. A button display name set on the operation submenu button display name 7011 is stored on the “displayname” attribute. Moreover, a screen set on the display-screen-selection in button pushed-down state 7012 is stored on the “window” attribute, and an operation set on the processing setting carried-out in button pushed-down state 7013 is stored on the “action” attribute.

According to the technology of the prior art described in Patent Document 1, by operating the thumbnail of image data stored on a lower hierarchy folder to be displayed on an folder icon, file operations (deleting, and copying) on file itself can be carried out. However, functions of the MFP using image data, such as a print function and a send function, were not able to be activated. Moreover, a user was not able to arbitrarily set functions specific to the MFP and parameters during operation, as the operation when a thumbnail to be displayed on a folder icon.

By using the intra-folder thumbnail display setting screen 700 and the operation submenu setting screen 701 according to the present invention, a user can carry out the following settings. That is, the user can set functions specific to the MFP, such as the print function and the send function, as the functions capable of being activated when selecting the thumbnail of a piece of image data stored on a lower hierarchy folder to be displayed on the folder icon. Accordingly, it is possible to improve convenience of the user in a screen operation.

### Flow of Processing

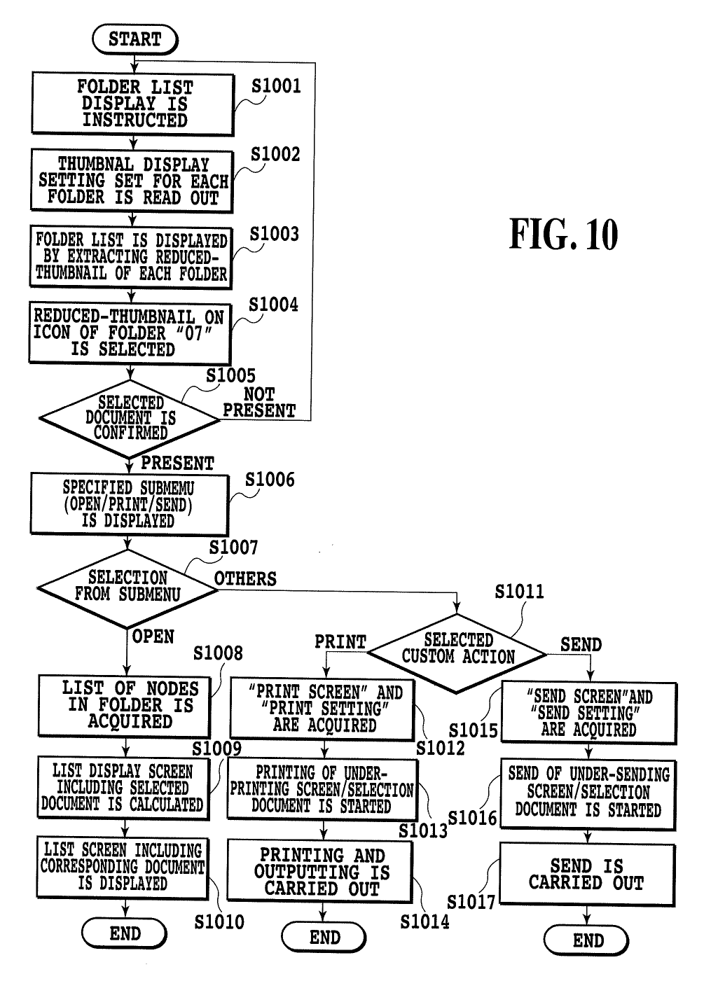

The flowchart in FIG. 10 briefly illustrates outline of a series of processings of a box function selecting an image to carrying out processing on it in the MFP 100 that is an image forming apparatus according to the representative embodiment of the present invention.

FIG. 10 is a flowchart illustrating an example of the screen flow described in FIG. 6 (and FIG. 5). In the following flow, the scanner control section 204, the printer control section 205, the operation control section 206, the image processing section 207, the image-information managing section 209, the folder-list-display setting control section 210, the job control section 211, and the sending-control section 212 are processing modules constituting the MFP control section. These processing modules are modules operating as parts of application programs or programs used by the CPU 201.

In the FIG. 10, the storage section 208 and the image-information storage section 2081 and folder-information storage section 2082 each being a part of the section 208 are information storage device constituting the MFP control section 200 of the MFP 100. These information storage devices store information on a nonvolatile hard-disc and a memory using file systems or database systems. Moreover, it is possible to directly access specific information stored on the storage section 208 under a specific key or condition.

At Step S1001, by user's operation on the operation section 300 of the MFP 100, the operation control section 206 detects that the box function is selected, and starts processing for displaying a list screen of folders as a screen of the box function.

At Step S1002, the folder-list display setting control section 210 acquires the number of reduced-thumbnails of intra-folder images to be displayed on each of the folders. The number is acquired from the “num” attribute 9011 of the “thumbnail” element 901 of the folders (“00” to “07” in the example of FIG. 6) in the folder-information managing table 900 that is stored in the folder-information storage section 2082. Moreover the section 210 acquires a way of extracting the reduced-thumbnail of each folder from the “disp-order” attribute 9012 of the element 901 of the folders in the table 900 that is stored in the folder-information storage section 2082. In addition, these attributes and the elements values can be set variously at a step (not illustrated in the figure) before Step S1001.

At Step S1003, the image-information managing section 209 instructed by the folder-list display setting control section 210 acquires the reduced-thumbnail image of the intra-folder image data on each of the folders from the image-information managing table 800 that is stored in the image-information storage section 2081. Ways of extracting the reduced-thumbnail to be set in the “disp-order” attribute 9012 include the following cases. That is, selection in reverse chronological order of updated date of pieces of image data included in a folder, selection in descending order of usage frequency of pieces of image data, selection from the head of sorted order (for example; in order of names) of images; and selection at regular intervals in sorted order (for example, order of names) of images. The section 209, according to the way of extracting reduced-thumbnails set in the “disp-order” attribute 9012 of each folder, acquires reduced-thumbnails by a number set in the “num” attribute 9011. Next, by the control of the operation control section 206, a screen as exemplified by the folder list screen 5000 in FIG. 6 is displayed on the touch panel section 301. On each of the folder icons 402 of the folders (“00” to “07” in the example of FIG. 6) on the screen 5000, the reduced-thumbnail image of the intra-folder image of each folder is displayed on each of the intra-folder reduced-thumbnail buttons 501.

At Step S1004, by user's operation on the operation section 300 of the MFP 100, the operation control section 206 detects that one of the intra-folder reduced-thumbnail buttons 501 is selected. If the case in FIG. 6 is exemplified, the section 206 detects that the button 501 of “photograph of a car” that is one of two reduced-thumbnail images displayed on the folder icon of the folder “07” is selected.

Next, at Step S1005, the image information managing section 209 again acquires information of a piece of image data “car.jpg” associated with the reduced-thumbnail image and stored on the image-information managing table 800. Then, if the piece of image data is already deleted, the process will return to Step S1001, and display a list screen again. If the image data is still present, information whether the “availability” element included in the “documentinfo” element 802 of the corresponding image data can carry out “print” or “send” is acquired from the table 800. The processing is carried out by the section 209. Subsequently, the process advances to Step S1006.

At Step S1006, the folder list display setting control section 210 acquires setting items of the operation submenu buttons from the “submenu” elements 902, 903 and 904 registered for the folder “07” in the folder-information managing table 900. For example, the setting items of the operation submenu buttons 601 on which “open”, “print” and “send” are arranged, are acquired. Among setting items of the buttons 601 acquired at Step S1006, items determined as “not available” by the “availability” element acquired at Step S1005, are removed from the display items of the buttons 601. Then, by the control of the operation control section 206, the buttons 601 exemplified in FIG. 6 are displayed.

At Step S1007, if, by user's operation on the operation section 300, the operation control section 206 detects that a default button “open” is pushed down out of the operation submenu buttons 601 as shown in FIG. 5, the process will advance to Step S1008. On the contrary, as illustrated in FIG. 6, if buttons except for the “open” button is pushed down, the process will advance to Step S1011.

At Step S1008, the image-information managing section 209 searches the image-information managing table 800 that is stored in the image-information storage section 2081 to acquire a list of contents (list of folders and sub-folders) stored on folders after the folder “07” (/users/07).

At Step S1009, the image-information managing section 209 selects images from the list of contents from the head by a number (eight) that can be displayed on the list display area 401 at once. If the piece of image data “car.jpg” indicated by the intra-folder reduced thumbnail button 501 is not present in the selected eight images, the section 209 will acquire the next eight contents from the list of contents in the folder. In this manner, the section 209 repeats to acquire the contents in the folder until the image data “car.jpg” indicated by the button 501 is included.

At Step S1010, by the control of the operation control section 206, eight images including “car.jpg” on the list display area 401 are displayed on the touch panel section 301 as the intra-folder list screen 4002. By this, a series of flowcharts will be finished.

At Step S1011, if, by user's operation on the operation section 300, the button “print” is pushed down out of operation submenu buttons 601, the process will advance to Step S1012, and if the button “send” is pushed down, the process will advance to Step S1015.

At Step S1012, the folder-list display setting control section 210 searches information regarding “print” from the “submenu” element 903 of the folder-information managing table 900 that is stored in the folder information storage section 2082. The section 210 acquires “print screen” as a screen to be displayed from the “window” element, from the “submenu” element 903 as a screen to be displayed, and acquires “print” processing and processing parameters from the “action” element as an operation to be carried out.

Next, at Step S1013, the job control section 211 starts “print” processing of the image data “car.jpg” selected at Step S1004. In the “print” processing of the section 211, the operation control section 206 displays the print screen 602. The initial setting of print displayed on the screen 602 reflects the processing parameters acquired at Step S1012, and color segmentation: auto, paper size: auto (A4), print face: double-surface are selected.

At Step S1014, by an instruction of the job control section 211, the printer control section 205 prints and outputs the image data “car.jpg” selected at Step S1004. The section 205 controls sections such as the laser exposure section 102, the image forming section 103, the fixing section 104, and the paper feed/conveying section 105 to print and output an image on a recording paper, and completes its job. By this, a series of flowcharts are finished.

At Step S1015, the folder list display setting control section 210 searches information regarding “send” from the “submenu” element 904 of the folder-information managing table 900 that is stored in the folder information storage section 2082. The section 210 acquires “send screen”, as a screen to be displayed from the “window” element, from the acquired “submenu” element 904 regarding “send”, and acquires “send” processing and processing parameters from the “action” element as an operation to be carried out.

Next, at Step S1016, the job control section 211 starts “send” processing of the image data “car.jpg” selected at Step S1004. In the “send” processing of the job control section 211, the operation control section 206 displays the send screen. The setting of send displayed on the send screen reflects the processing parameters acquired at Step S1015, and send destination: electronic mail, send address: userl@mail are selected.

At Step S1017, by an instruction of the job control section 211, the sending-control section 212 sends the image data “car.jpg” selected at Step S1004. The section 212, by sending the image data to an external send destination with an electronic mail via the external interface 203, completes its send job. By 1 this, a series of flowcharts are finished.

In addition, according to the present embodiment, although “image data” to be stored on the storage section of the MFP has been described as a specific example, the target may also be “file data” or “document data” that is constructed by a plurality of files.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-028584, filed Feb. 10, 2009, which is hereby incorporated by reference herein in its entirety.

What is claimed is:

1. An image forming apparatus comprising:
a thumbnail list display component configured to extract contents including files and folders having a hierarchy structure by a number to be displayed on a display section and to display a list of the extracted contents on the display section in a form of thumbnail images or icons;
a reduced-thumbnail image display component configured to extract, when displaying folders on the display section, reduced-thumbnail images obtained by reducing thumbnail images of the contents included in the folders and to display the reduced-thumbnail images on an icon of the folder to be displayed in a list; and
a reduced-thumbnail display setting component configured to set a way of extracting the reduced-thumbnail images when they are displayed.

2. The image forming apparatus according to claim 1, wherein
the reduced-thumbnail display setting component sets the number of the reduced-thumbnail images to be extracted.

3. The image forming apparatus according to claim 1, wherein
the reduced-thumbnail display setting component sets extraction criteria of the reduced-thumbnail images to be extracted.

4. The image forming apparatus according to claim 1, wherein
the reduced-thumbnail display setting component sets an extraction way individually for each folder.

5. The image forming apparatus according to claim 1, further comprising a processing operation setting component configured to set a processing operation when it is detected that the reduced-thumbnail image to be displayed on an icon of the folder is selected.

6. The image forming apparatus according to claim 5, wherein
the processing operation setting component sets a plurality of processing operations; and
further includes a component configured to present a setting menu regarding setting of the plurality of processing operations when it is detected that the-reduced thumbnail image is selected, and to carry out the selected processing operation based on a selection input by a user.

7. The image forming apparatus according to claim 5, wherein
the processing operation setting component sets a single processing operation; and
further includes a component configured to carry out the set processing operation when it is detected that the reduced thumbnail image is selected.

8. The image forming apparatus according to claim 5, wherein
the processing operation is an operation of displaying, in a list, contents included in a folder in which content shown by a selected reduced-thumbnail image is stored, together with the content shown by the reduced-thumbnail image.

9. The image forming apparatus according to claim 5, wherein
the processing operation includes at least one of print, send, and preview display of the content shown by the selected reduced thumbnail image.

10. The image forming apparatus according to claim 5, wherein
the processing operation setting component:
sets in advance parameters when carrying out the processing operation; and
acquires the set parameters when carrying out a processing operation for the content shown by the selected reduced-thumbnail image, and carries out the processing operation based on the parameters.

11. The image forming apparatus according to claim 5, wherein
the processing operation setting component sets a processing operation individually for each folder.

12. An image processing method comprising the steps of:
extracting contents including files and folders having a hierarchy structure by a number to be displayed on a display section and displaying a list of the extracted contents on the display section in a form of thumbnail images or icons;
extracting, when displaying folders on the display section, reduced-thumbnail images obtained by reducing thumbnail images of the contents included in the folders, and displaying the reduced-thumbnail images on an icon of the folder to be displayed in a list; and
setting a way of extracting the reduced thumbnail images when they are displayed.

13. A computer-readable recording medium recording thereon a program for causing a computer to execute the steps of:
extracting contents including files and folders having a hierarchy structure by a number to be displayed on a display section and displaying a list of the extracted contents on the display section in a form of thumbnail images or icons;
extracting, when displaying folders on the display section, reduced-thumbnail images obtained by reducing thumbnail images of the contents included in the folders, and displaying the reduced-thumbnails images on an icon of the folder to be displayed in a list; and
setting a way of extracting the reduced thumbnail images when they are displayed.
